(19) United States
(12) Patent Application Publication
(10) Pub. No.: US 2026/0323568 A1
(43) Pub. Date: Oct. 15, 2026

(54) LOCATION-BASED TERMINAL MOBILITY MANAGEMENT METHOD AND DEVICE IN MOBILE COMMUNICATION SYSTEM

(71) Applicant: SAMSUNG ELECTRONICS CO., LTD., Suwon-si, Gyeonggi-do (KR)

(72) Inventors: Hyesung KIM, Suwon-si (KR); Sungjin PARK, Suwon-si (KR); Jaehyeon BAE, Suwon-si (KR); Youngkyo BAEK, Suwon-si (KR); Dongeun SUH, Suwon-si (KR); Jicheol LEE, Suwon-si (KR)

(21) Appl. No.: 19/102,236

(22) PCT Filed: Aug. 4, 2023
(86) PCT No.: PCT/KR2023/011458

§ 371 Date: Feb. 7, 2025

(30) Foreign Application Priority Data
Aug. 11, 2022 (KR) 10-2022-0100778

(51) Int. Cl. H04W 64/00; H04W 12/06; H04W 12/63

(52) U.S. Cl. CPC H04W 64/00; H04W 12/06; H04W 12/63

(57) ABSTRACT

The present disclosure relates to a 5G or 6G communication system to support a higher data transmission rate. Specifically, the present disclosure relates to a device for managing the mobility of a terminal on the basis of a detailed location, the device comprising: a transceiver; and a controller coupled with the transceiver, wherein the controller may be configured to: receive configuration information configuring at least one cube associated with a three-dimensional space within a cell; receive, from a location management function (LMF) node, auxiliary information for location measurement; transmit, to a terminal, the auxiliary information for location measurement; receive, from the terminal concealed information associated with the location measurement of the terminal; identify an identifier (ID) of a cube associated with the terminal on the basis of the concealed information associated with the location measurement of the terminal; determine whether it is allowed to apply a mobility management policy based on the identifier of the cube to the terminal; and transmit information about the mobility management policy to the terminal.

### TECHNICAL FIELD

The disclosure relates to a mobile communication system (or a wireless communication system) and, more particularly, the disclosure relates to a terminal mobility management method in a mobile communication system (or a wireless communication system).

### BACKGROUND ART

5 G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6 G mobile communication technologies (referred to as Beyond 5 G systems) in terahertz (THz) bands (for example, 95 GHz to 3 THz bands) in order to accomplish transmission rates fifty times faster than 5 G mobile communication technologies and ultra-low latencies one-tenth of 5 G mobile communication technologies.

At the beginning of the development of 5 G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5 G mobile communication technologies in view of services to be supported by 5 G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

5 G mobile communication systems are commercialized, connected devices that have been exponentially increasing will be connected to communication networks, and it is accordingly expected that enhanced functions and performances of 5 G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5 G performance improvement and complexity reduction by utilizing Artificial Intelligence (AI) and Machine Learning (ML), AI service support, metaverse service support, and drone communication.

Furthermore, such development of 5 G mobile communication systems will serve as a basis for developing not only new waveforms for providing coverage in terahertz bands of 6 G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6 G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As communication systems evolve, the demand for more efficient methods to manage terminal mobility is growing.

### DISCLOSURE OF INVENTION

### TECHNICAL PROBLEM

In current mobile communication systems, terminal mobility management is not supported at a level smaller than a cell or tracking area (TA). This is because network entities (or network functions) of a core network cannot recognize detailed location of a terminal at a level smaller than a cell during an initial registration procedure of the terminal. To provide detailed location of the terminal to the core network during the initial registration procedure, an additional security measure is required. This is because the security of an initial registration request message transmitted by a terminal is not fully guaranteed, and detailed location information of the terminal is considered personal.

Accordingly, a method for managing terminal mobility at a level smaller than a cell is provided below. Specifically, a cube as an area unit, smaller than a cell used within a 5 G system and capable of specifying the three-dimensional location of a terminal, is provided. In this regard, specific procedures are provided, including a procedure in which a network entity (or network function) of a core network delivers cube map information that partitions a network coverage area into cube units to a terminal and a base station, a procedure in which information required to determine terminal detailed location information in a cube unit during a terminal registration procedure is transmitted to a terminal and a base station, and a procedure in which information on a cube area where a terminal is located is transmitted to a network entity without causing information leakage.

### SOLUTION TO PROBLEM

A method according to an embodiment of the disclosure includes a network entity transmitting information associated with location of a terminal to the terminal, and receiving a security message containing the location of the terminal from the terminal.

### ADVANTAGEOUS EFFECTS OF THE INVETION

According to various embodiments proposed in the disclosure, the three-dimensional location of a terminal can be identified at a more detailed level than a cell or a tracking area. This allows a network entity to manage mobility of a terminal, based on the three-dimensional location of the terminal, thereby enabling more efficient and specific terminal mobility management.

In addition, according to various embodiments proposed in the disclosure, detailed location of a terminal can be specified during an initial registration procedure or a periodic registration procedure of the terminal. This allows a network entity of a core network to apply an access and mobility management policy to a specific physical area (an area smaller than a cell or a tracking area, or an area that cannot be precisely defined only by a cell identifier (ID) or TAI).

In addition, according to various embodiments proposed in the disclosure, during the initial registration procedure, information such as detailed location of a terminal, which requires personal information security, can be contained in a registration request message and transmitted even before non-access stratum (NAS) security is guaranteed, thereby enabling safe maintenance of personal information security.

### BRIEF DESCRIPTION OF DRAWINGS

FIG. 1 illustrates an example of a structure of a 5 G core network related to the disclosure.

FIG. 2 illustrates a procedure for managing terminal mobility in relation to an embodiment proposed in the disclosure.

FIG. 3 illustrates a procedure for managing terminal mobility, based on a detailed location in relation to an embodiment proposed in the disclosure.

FIG. 4 illustrates a procedure for managing terminal mobility, based on a detailed location in relation to an embodiment proposed in the disclosure.

FIG. 5 illustrates a procedure for managing terminal mobility, based on a detailed location in relation to an embodiment proposed in the disclosure.

FIG. 6 illustrates a procedure for managing terminal mobility, based on a detailed location in relation to an embodiment proposed in the disclosure.

FIG. 7 illustrates a structure of a terminal according to embodiments of the disclosure.

FIG. 8 illustrates a structure of a base station according to embodiments of the disclosure.

FIG. 9 illustrates a structure of a network function (or network entity) according to embodiments of the disclosure.

### MODE FOR THE INVENTION

Hereinafter, exemplary embodiments of the disclosure will be described in detail with reference to the accompanying drawings. It should be noted that in the accompanying drawings, the same like elements are designated by the same or like reference numerals. Also, a detailed description of known functions or configurations that may make the subject matter of the disclosure unnecessarily unclear will be omitted.

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in various embodiments of the disclosure may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) or new radio (NR) standards are used for the sake of descriptive convenience. However, the disclosure is not limited by these terms and names, and may be applied in the same way to systems that conform other standards.

In the following description, a base station (BS) is an entity that allocates resources to terminals, and may be at least one of a radio access network (RAN) node, a next generation node B (gNode B, gNB), an evolved node B (eNode B, eNB), a Node B, a wireless access unit, a base station controller, and a node on a network. In the disclosure, the term “eNB” may be interchangeably used with the term “gNB” for the sake of descriptive convenience. That is, a base station described as “eNB” may refer to “gNB”.

A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5 G communication technology and Internet of things (IoT)-related technology. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a terminal (or UE) transmits data or control signals to a base station (BS) (or eNB, gNB), and the downlink indicates a radio link through which the base station transmits data or control signals to the terminal. The above multiple access scheme separates data or control information of respective users by allocating and operating time-frequency resources for transmitting the data or control information for each user so as to avoid overlapping each other, that is, so as to establish orthogonality.

Since a 5 G communication system, which is a post-LTE communication system, must freely reflect various requirements of users, service providers, and the like, services satisfying various requirements must be supported. The services considered in the 5 G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5 G communication system, eMBB must provide a peak data rate of 20 Gbps in the downlink and a peak data rate of 10 Gbps in the uplink for a single base station. Furthermore, the 5 G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5 G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5 G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5 G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5 G system must provide a transmit time interval (TTI) shorter than those of other services, and also may require a design for assigning a large number of resources in a frequency band in order to secure reliability of a communication link.

The above-described three services considered in the 5 G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely examples of different types of services, and service types to which the disclosure is applied are not limited to the above examples.

Furthermore, in the following description, LTE, LTE-A, LTE Pro, 5 G (or NR), or 6 G systems will be described by way of example, but the embodiments of the disclosure may also be applied to other communication systems having similar technical backgrounds or channel types. In addition, based on determinations by those skilled in the art, the embodiments of the disclosure may be applied to other communication systems through some modifications without significantly departing from the scope of the disclosure.

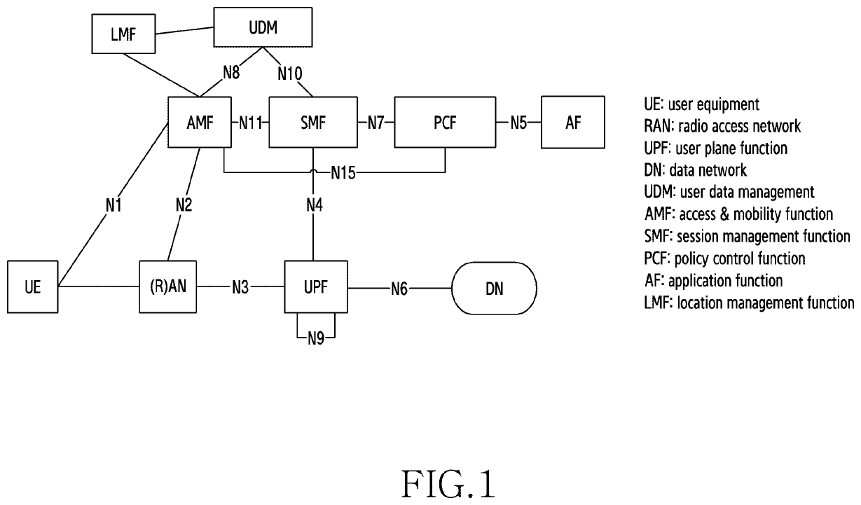

FIG. 1 illustrates an example of a structure of a 5 G core network related to the disclosure.

A 5 G system structure supporting an edge computing system may include various network functions (NFs) or network entities. FIG. 1 illustrates an access and mobility management function (AMF), a session management function (SMF), a policy control function (PCF), an application function (AF), a unified data management (UDM), a data network (DN), a user plane function (UPF), a location management function (LMF) as examples of such network functions or network entities, and also illustrates a (radio) access network ((R)AN) and a user equipment (UE) of the 5 G core network.

The NFs illustrated in FIG. 1 support the following functions.

AMF: AMF provides functions for access and mobility management of the UE units, and each UE is typically connected to a single AMF by default.

DN: DN refers to a network outside of the 5 G system (5 GS) where, for example, operator services, Internet access, or third-party services exist. DN transmits a downlink protocol data unit (PDU) to UPF or receives, from UPF, an uplink PDU transmitted from UEs.

PCF: PCF provides functions for determining policies, such as mobility management and session management, by receiving information on a packet flow from an application server. Specifically, PCF supports functions such as supporting a unified policy framework for controlling network operations, providing policy rules to allow control plane function(s) (e.g., AMF, SMF, etc.) to enforce policy rules, and implementing a front end for accessing related subscription information for policy decisions in a user data repository (UDR).

SMF: SMF provides session management functions, and when a UE has multiple sessions, each session may be managed by a different SMF.

UDM: UDM stores user subscription data, policy data, etc.

UPF: UPF delivers, to the UE via (R) AN, a downlink PDU received from DN and delivers, via (R) AN to DN, an uplink PDU received from the UE.

AF: AF interacts with 3 GPP core network to provide services (e.g., support functionality such as application impact on traffic routing, access to network capability exposure, and interaction with policy frameworks for policy control).

LMF: LMF supports functions related to UE location measurement and location-related information provision in conjunction with AMF, UDM, NEF, etc.

The network functions or network entities illustrated in FIG. 1 are some of nodes that constitute the 5 G core network, and the 5 G core network may include more network functions or network entities than these examples.

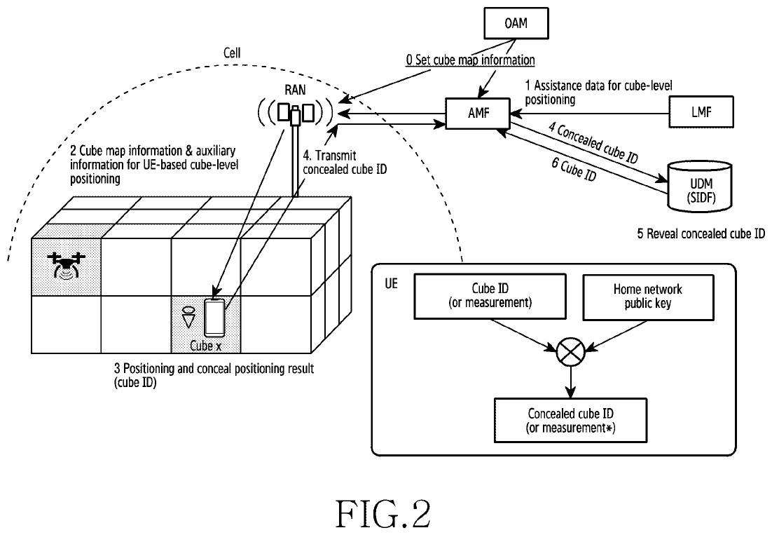

FIG. 2 explains a procedure for managing UE mobility in relation to an embodiment proposed in the disclosure.

FIG. 2 illustrates an example operation for performing UE mobility management at a level smaller than a cell unit. For explanation, a unit smaller than a cell in relation to the disclosure may be defined as a cube hereinafter. Specifically, FIG. 2 illustrates a process of dividing a space into cube units, and a procedure for specifying the UE location in a cube unit and tracking, in a cube unit, the UE location in a mobile communication network. A cube may have a regular hexahedron or rectangular parallelepiped shape and may be specified or described using three coordinates in three dimensions.

For example, Table 1 below represents a set of one or more pieces of information for defining and using a cube, and for example, this set of information may be defined as a name called data type for cube. Data type for cube may be expressed by one or more attributes as shown in Table 1, and for example, may include a cube or rectangular cuboid value as a shape attribute value, and may include a 3D point value for representing the area and size of an actual cube as a point list attribute value. In addition, data type for cube may include a cell ID (identifier) or TA ID as an associated cell(s) attribute value or an associated tracking area(s) attribute value to represent information on a cell or TA that includes the corresponding cube area or is adjacent to the corresponding cube area. Data type for cube may be information for representing one cube and may include multiple cell IDs or TA IDs for this one cube. Furthermore, data type for cube may also include a cube-specific identifier (ID) as an attribute value.

TABLE 1

| Attribute | | | |
|---|---|---|---|
| name | Data type | Cardinality | Description |
| shape | SupportedShapes | 1 | Cube or Rectangular Cuboid |
| pointList | array(GeographicalCoordinates) | 4 | 3Dpoints (e.g., latitude, |
| | | | longitude, altitude) |
| Cube ID | Cube ID | 1 | Cube Identifier |
| Associated | Cell ID | xx | Cell identifier(s) |
| cell(s) | | | |
| Associated | Tracking Area ID | xx | Tracking Area ID(s) |
| tracking | | | |
| area(s) | | | |

Using the cubes defined above, a specific region or a service region of a mobile communication network may be divided into zones without gaps (i.e., tessellation with cubes), and the result therefrom may be expressed as a cube map. A cube map may be defined as a cube list containing one or more cubes, and the data type for representing a cube map may be defined as shown in Table 2 below.

As shown in Table 2, data type for cube map may be defined by cube list, cube identifier, cell ID, and TA ID. When data type for cube map includes attribute values related to cell ID or TA ID, data type for cube map may be understood as expressing the result of zoning (or dividing) the corresponding cell area or TA into cubes. In this case, data type for cube map may be interpreted as information specific to the corresponding cell or TA and may be invalid information in other cells or TAs.

TABLE 2

| Attribute | | | |
|---|---|---|---|
| name | Data type | Cardinality | Description |
| shape | SupportedShapes | 1 | It shall take the value Cube map |
| CubeList | array(Cubes) | xx | Array with up to xx items, where each |
| | | | item is a Cube |
| CubeIDList | Array(CubeIDList) | xx | List of cube IDs |
| Cell ID(s) | Cell ID(s) | xx | Cell ID |
| Tracking area | Tracking | xx | Tracking area ID |
| ID(s) | area ID(s) | | |

In the detailed description of the disclosure, the shape of a specific cube is limited to a regular hexahedron or a rectangular parallelepiped and used in the description of the following embodiments. However, it is of course possible to make various modifications to the shape of the cube without departing from the scope of the disclosure. For example, the shape of the cube may be defined as another shape of a convex hexahedron or a hexagonal prism, and it is of course also included in the disclosure provided herein. In these other examples, when defining a cube in the shape of a hexahedron or a hexagonal prism rather than a convex regular hexahedron/rectangular parallelepiped, the value corresponding to the shape in the set of information indicated by the data type for cube, the value of pointList, and the cardinality value may have different values from those in Table 1.

Accordingly, new operations and functions are required for the core network to track UE location and manage mobility, based on cube information and cube map information.

First, an operation is required to configure the cube map information for the network function and RAN. For example, the cube map information may be configured for network entities (or network functions) such as LMF, AMF, and RAN via an operation and management (OAM) system.

In addition, an operation is required to transmit, to the UE, all or part of the cube map information configured for each entity (or function) such as LMF, AMF, and RAN. For example, LMF may transmit the cube map information to the UE via AMF and RAN.

The LMF may transmit or provide, to the AMF, RAN, and the UE, information (e.g., assistance data) necessary to specify UE location in a cube unit. The information necessary to specify the location in a cube unit may include at least one of global positioning system (GPS) auxiliary information required for UE positioning, location information of base station transceiver points required for performing 3GPP-based positioning, related signaling configuration information (e.g., DL/UL positioning reference signal (PRS) configuration information), and cube map information. In addition, the LMF may receive a measurement value from the UE and perform an operation of directly specify the UE location in a cube unit. The LMF may provide the AMF with a cube identifier determined as a result of the operation described above.

The AMF may deliver, to the UE via the RAN, the cube map information received from the LMF and the auxiliary information necessary for measuring the UE location in a cube unit. In addition, the AMF may determine whether the UE supports cube-level mobility management, based on the signaling received from the UE. In addition, the AMF may identify the subscriber information for the UE in conjunction with the UDM and identify whether the network allows cube-level mobility management for the UE. In addition, the AMF may apply or enforce, with respect to the UE, an access and mobility management policy (AM policy) applied on a cube-unit basis.

The RAN may deliver, to the UE, at least one of the configured cube map information, the cube map information received from the LMF via the AMF (e.g., cell-specific cube map information or TA-specific cube map information), or the auxiliary information required for measuring the UE location in a cube unit (e.g., GPS auxiliary information, location information of base station transceiver points required for 3GPP-based positioning, signaling configuration information such as related DL/UL PRS configuration information, and cube map information). The method by which the RAN delivers the above-described information to the UE may include a method of periodically broadcasting information (e.g., including information in a system information block (SIB) to periodically transmit the same) or a method of transmitting the cube map information or the auxiliary information necessary for measuring UE location in a cube unit in response to an on-demand SIB requested by the UE during an initial access procedure. In addition, the RAN may perform AM policy enforcement applied to the UE on a cube-unit basis, based on the information received from the AMF.

The UE may perform an operation of determining a cube identifier (cube ID) of the cube in which the UE is located, based on information received from the network (cube map information and auxiliary information necessary for measuring the UE location in a cube unit).

In addition, the UE may perform a concealment operation for the cube identifier, based on information configured in the universal subscriber identify module (USIM) or universal integrated circuit card (UICC) of the UE, and the UE may transmit the concealed cube identifier to the AMF via the RAN. This concealment operation may be performed using the home network public key configured in the UE.

In addition, the UE may provide the measurement value required for calculating the UE location to the network function or the network entity (e.g., LMF or AMF) without directly determining the cube identifier according to the information configured in the UE or the information received from the network.

In addition, the UE may monitor its own location, based on the cube map information and transmit the cube identifier information of the UE to the AMF according to a specific condition (cube identifier reporting condition received from the network).

The UDM may perform an operation of revealing or de-concealing the cube identifier concealed with the home network public key or the location-related measurement value of the UE at the request of the AMF or the LMF. In addition, the UDM may store subscriber information related to whether cube-level mobility management is allowed for the UE, and provide the related information to the AMF or the LMF.

Hereinafter, the UE mobility management procedure described above will be specifically described.

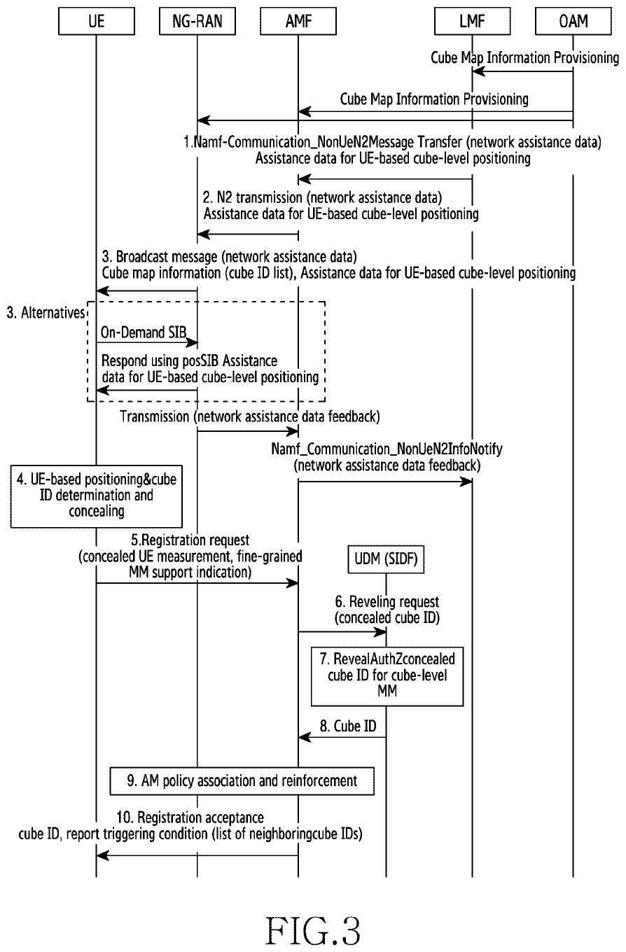

FIG. 3 illustrates a procedure for managing UE mobility, based on a detailed location in relation to an embodiment proposed in the disclosure. FIG. 3 specifically explains a cube-level mobility management procedure.

0. The OAM system configures cube map information for network entities (or network functions) such as RAN, AMF, and LMF. When cube map information is configured to the RAN, OAM may configure, to RAN, only cube map information corresponding to the coverage area or cell area of the RAN. For example, cube map information configured to the RAN may include only information corresponding to cell ID broadcasted by the RAN. When cube map information is configured to AMF, OAM may configure, to the AMF, only cube map information corresponding to AMF service area defined by TA(s) of the AMF. For example, when AMF service area is expressed by TA ID list, cube map information configured to the AMF may include cube map information corresponding to the corresponding TA ID. Alternatively, when the OAM configures, to the AMF, cube map for a specific UE, the corresponding cube map may include only information corresponding to registration area of the UE. For example, when the registration area of the UE configured by the AMF is expressed as a TA ID list, cube map information corresponding to the TA ID list may be configured to the AMF according to each UE. When the OAM configures cube map information to LMF, cube map information corresponding to the service area of LMF may be configured to the LMF.

1. The LMF transmits or provides, to AMF, assistance data (or auxiliary information) necessary for measuring UE location in a cube unit. The assistance data (or information) refers to information necessary for the UE or RAN to measure the UE location, and information on at least one of the following may be included in the assistance data (or information).

[TAI, Cell ID, TA-specific cube map information, cell-specific cube map information, DL-PRS configuration information for the RAN's transmission/reception point(s) (TRP(s)), synchronization signal block (SSB) for RAN TRPs, spatial direction information of the DL-PRS, and geographical coordinate information for TRPs]

The conditions under which the LMF provides the assistance data (or auxiliary information) described above may be as follows. When the LMF receives a request for assistance data from AMF, or receives a request from an external application function (AF) (via NEF), or when the service area of the LMF overlaps with a cube-level mobility management area, the LMF may provide assistance data to the AMF within the LMF service area.

2. AMF transmits, to RAN, assistance data required for measuring UE location in a cube unit, received from the LMF.

3. RAN transmits, to the UE, at least one of the information previously received and configured from OAM (e.g., cube map information including a cube ID list) and assistance data required for measuring UE location in a cube unit, received from AMF.

The methods by which RAN transmits the aforementioned information to the UE may follow two approaches, as described below. The RAN may include the information in a broadcast message and broadcast the same periodically. Alternatively, when the UE transmits, to the RAN, an on-demand system information block (SIB) message including a cube-level positioning, cube-level mobility management indication, or flag, the RAN may include the above-described assistance data in a RAN response message and transmit the same to the UE.

4. The UE calculates the UE location coordinates by measuring/calculating UE location by using at least one of information received from the RAN, a GPS module installed inside the UE, and a sensor, and compares the calculated coordinates with the cube map information to determine the cube where the UE is located. The UE may perform an operation of transmitting the corresponding cube ID to the RAN and AMF.

Specifically, the UE performs concealment on the determined cube ID by using the home network public key configured in the UE, and generates a concealed cube ID. For example, when a cube ID concealment indication is configured in the USIM of the UE, the UE may calculate and generate a concealed cube ID by using the home network public key stored in the USIM. When the cube ID concealment indication is not configured in the USIM, the UE may encrypt the cube ID using another encryption method.

5. The UE transmits the generated concealed cube ID to the AMF. The concealed cube ID may be included in the registration request message of the UE and then transmitted. When the concealed cube ID is transmitted to the AMF, the UE may provide, to the AMF, at least one of a fine-grained mobility management (MM) support indication, a method by which the UE encrypted the cube ID, a cube ID concealment method (e.g., whether to use a home network public key, encryption scheme information, etc.), and a UE identifier together with the concealed cube ID.

6. When AMF receives a concealed cube ID from the UE and the cube ID concealment method employs a home network public key, the AMF may transmit the concealed cube ID to the UDM together with the UE identifier. In addition, when the UE indicates support for fine-grained mobility management through a fine-grained MM support indication, the AMF may request the UDM for related subscriber information.

7. The UDM performs a de-concealment operation for the concealed cube ID by using the home network private key. This operation is performed in the subscriber identity de-concealing function (SIDF) of the UDM.

The UDM may also identify whether fine-grained mobility management or cube-level mobility management is allowed for the UE, based on subscriber information. In addition, de-concealment operation may be performed only when fine-grained mobility management or cube-level mobility management is allowed for the UE according to the network operator's policy and subscriber information. For example, when fine-grained mobility management is not supported by the UE or cube-level mobility management is not allowed for the UE, the UDM may provide a rejection response to AMF without performing de-concealment operation for cube ID.

8. The UDM transmits the cube ID to the AMF, as a result of performing cube ID de-concealment. The UDM may also provide, to the AMF, subscriber information indicating that fine-grained mobility management or cube-level mobility management is allowed for the UE. The AMF may provide, to the RAN, the cube ID of the cube area where the UE is located.

9. The AMF may perform AM policy association using the cube ID received from the UDM. For example, the AMF may provide, to the PCF, the cube ID of the cube where the UE is located and receive, from the PCF, policy information that should be applied in the corresponding cube area. The policy information that the AMF receives from the PCF may include at least one of the following.

Cube-level mobility restriction or service area restriction (allowed cube ID list, non-allowed cube ID list)

Cube-level RFSP (RAT Frequency Selection Priority) Index value: RAT Frequency Selection Priority value configured for cube area, which may correspond to subscriber profile ID for RAT/Frequency Priority

Cube-level UE-AMBR (aggregate maximum bitrate) or UE Slice-MBR (maximum bitrate)

When the AMF receives, from the PCF, an AM policy including a cube-level RFSP (Radio access type/Frequency of Selection Priority) Index, the AMF transmits the RESP Index value to RAN, and the RAN may perform RAT/Frequency selection, based on RAT Frequency selection priority. In addition, the AMF may provide, to the RAN, a cube ID corresponding to the location of the UE.

10. The AMF transmits, to the UE, at least one of the cube ID (de-concealed cube ID) obtained from the UDM, the reporting triggering condition (list of neighbor cube ID list), and the flag to perform cube-level mobility tracking.

After operation 10, the UE identifies whether the cube ID received from the AMF matches the cube ID determined in operation 4 by the UE, and monitors whether the UE exits the cube area identified by the cube ID included in the cube ID list included in the reporting triggering condition provided by the AMF. This monitoring may be performed via UE-based positioning as in operation 4.

When the UE exits the cube area included in the cube ID list included in the reporting triggering condition and enters a new cube area, the UE transmits the corresponding cube ID to the AMF while re-performing registration. At this time, when the re-performed registration procedure is a registration update, NAS signaling security may be guaranteed, so that the cube ID may be transmitted to the AMF via NAS signaling with security applied, without concealment by using a separate method as in operation 4 above.

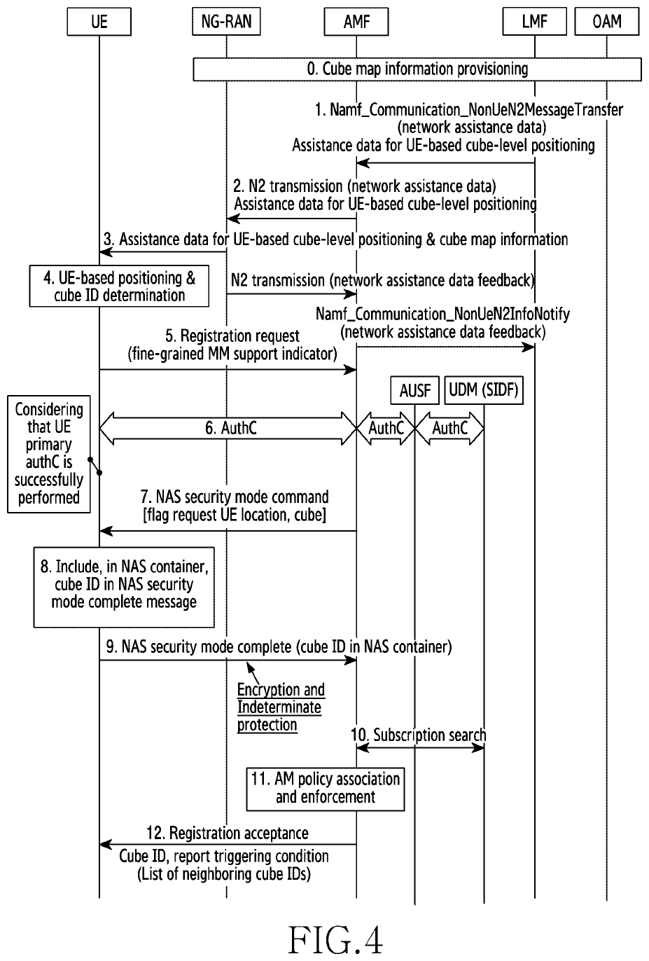

FIG. 4 illustrates a procedure for managing UE mobility, based on a detailed location in relation to an embodiment proposed in the disclosure. FIG. 4 specifically explains an operation after the NAS security mode control procedure is completed, in relation to a cube-level mobility management procedure.

0. The OAM system configures cube map information for network entities (or network functions) such as RAN, AMF, and LMF. When cube map information is configured to RAN, OAM may configure, to RAN, only cube map information corresponding to the coverage area or cell area of the RAN. For example, cube map information configured to the RAN may include only information corresponding to cell ID broadcasted by the RAN. When cube map information is configured to AMF, OAM may configure, to the AMF, only cube map information corresponding to AMF service area defined by TA(s) of the AMF. For example, when AMF service area is expressed by TA ID list, cube map information configured to the AMF may include cube map information corresponding to the corresponding TA ID. Alternatively, when the OAM configures, to the AMF, cube map for a specific UE, the corresponding cube map may include information corresponding to registration area of the UE. For example, when the registration area of the UE configured by the AMF is expressed as a TA ID list, cube map information corresponding to the TA ID list may be configured to the AMF according to each UE. When the OAM configures cube map information to LMF, cube map information corresponding to the service area of the LMF may be configured to the LMF.

1. LMF transmits or provides, to AMF, assistance data (or auxiliary information) necessary for measuring UE location in a cube unit. The assistance data (or information) described above refers to information necessary for the UE or RAN to measure the UE location, and information on at least one of the following may be included in the assistance data (or information).

[TAI, Cell ID, TA-specific cube map information, cell-specific cube map information, DL-PRS configuration information for the transmitter/receiver point(s) of the RAN, SSB for RAN TRPs, spatial direction information of the DL-PRS, and geographical coordinate information for TRPs]

The conditions under which the LMF provides such assistance data (or information) may be as follows: When the LMF receives an assistance data request from AMF, or receives a request from an external AF (via NEF), or when the service area of the LMF overlaps with the cube-level mobility management area, the LMF may provide assistance data to the AMF within the LMF service area.

2. The AMF transmits, to the RAN, assistance data required for measuring UE location in a cube unit, received from the LMF.

3. The RAN transmits, to the UE, at least one of the information previously received and configured from the OAM (e.g., cube map information including a cube ID list) and assistance data required for measuring UE location in a cube unit, received from the AMF.

The methods by which RAN transmits the aforementioned information to the UE may follow two approaches, as described below. The RAN may include the corresponding information in a broadcast message and broadcast the same periodically. Alternatively, the RAN may include the assistance data in a RAN response message and transmit the same to the UE when the UE transmits, to the RAN, an on-demand system information block (SIB) message including a cube-level positioning, cube-level mobility management indicator or flag.

4. The UE calculates the location coordinates of the UE via UE location measurement/calculation by using at least one of information received from the RAN, a GPS module installed inside the UE, and a sensor, and compares the calculated coordinates with the cube map information to determine the cube where the UE is located. The UE may perform an operation of transmitting the corresponding cube ID to the RAN and AMF.

Specifically, when the cube ID concealment indicator is not configured in the USIM or the guide information related to cube ID transmission is not received from the RAN, or cube ID concealment is not supported by the UE, the UE may not conceal the cube ID determined in the previous operation and may not include the cube ID in the initial registration request.

5. The UE may transmit, to AMF, a registration request message including the UE identifier and at least one of a fine-grained MM support indication, a cube-level MM support indication, or a UE capability to support cube-level MM.

6. AMF performs authentication and security related procedures in conjunction with the UE, AUSF, and UDM, based on the information received from the UE. The UDM may inform the AMF of information on whether fine-grained MM or cube-level MM is supported or allowed for the UE.

7. When the AMF successfully performs the mutual authentication procedure with the UE in the previous operation, the AMF transmits NAS security mode command to the UE. At this time, when the AMF received fine-grained MM support indication or cube-level MM support indication or UE capability to support cube-level MM from the UE in operation 5, the AMF may transmit flag requesting UE location or flag requesting cube ID together while transmitting NAS security mode command to the UE.

8. When the UE receives the flag requesting UE location or flag requesting cube ID from the AMF, the UE generates an NAS container including the cube ID determined in operation 4. The NAS container may include information containable in the registration request message along with the cube ID and the UE identifier. In addition, the UE may apply ciphering and integrity protection schemes to the NAS container.

9. The UE transmits the NAS container including the cube ID to the AMF.

10. When the AMF receives the cube ID from the UE, the AMF may select the UDM and request the subscriber information related to cube-level mobility management for the UE. The UDM may also provide, to the AMF, the subscriber information indicating that fine-grained mobility management or cube-level mobility management is allowed for the UE.

11. The AMF may perform AM policy association by using the cube ID received from UDM. For example, the AMF may provide, to the PCF, the cube ID of the cube where the UE is located and receive, from the PCF, policy information that should be applied in the corresponding cube area. The policy information that the AMF receives from the PCF may include at least one of the following.

Cube-level mobility restriction or service area restriction (allowed cube ID list, non-allowed cube ID list)

Cube-level RFSP (RAT Frequency Selection Priority) Index value: RAT Frequency Selection Priority value configured for the cube area, which may correspond to subscriber profile ID for RAT/Frequency Priority

Cube-level UE-AMBR (aggregate maximum bitrate) or UE Slice-maximum bitrate (MBR)

When the AMF receives, from the PCF, an AM policy including a cube-level RFSP Index, the AMF may transmit the RFSP Index value to the RAN and perform RAT/Frequency selection in RAN, based on RAT Frequency selection priority. In addition, the AMF may provide, to the RAN, a cube ID that matches the location of the UE.

12. The AMF transmits, to the UE, at least one of the cube ID (de-concealed cube ID) obtained from UDM, the reporting triggering condition (list of neighbor cube ID list), and the flag to perform cube-level mobility tracking.

After operation 10, the UE identifies whether the cube ID received from AMF matches the cube ID determined in operation 4 by the UE, and monitors whether the UE exits the cube area identified by the cube ID included in the cube ID list included in the reporting triggering condition provided by the AMF. This monitoring can be performed through UE-based positioning as in step 4.

When the UE exits the cube area included in the cube ID list included in the reporting triggering condition and enters a new cube area, the UE transmits the corresponding cube ID to the AMF while re-performing registration.

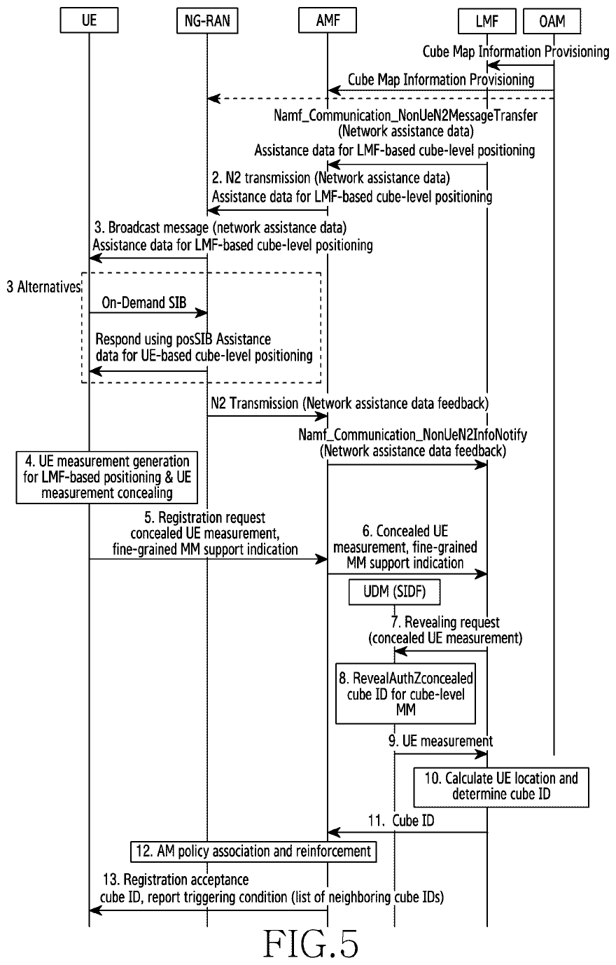

FIG. 5 illustrates a procedure for managing UE mobility, based on a detailed location in relation to an embodiment proposed in the disclosure. FIG. 5 specifically explains an LMF-based method in relation to a cube-level mobility management procedure.

0. As in the embodiments described above in FIGS. 3 and 4, the OAM system may configure cube map information for network entities (or functions) such as RAN, AMF, and LMF. According to the operator policy or the method for calculating UE location and determining the cube ID of the cube area where the UE is located, the cube map information may not be configured to the RAN. For example, when using a method for finally calculating the UE location in the network (e.g., LMF) and determining the cube ID, the cube map information may be configured only to the AMF and LMF and may not be configured to the RAN.

1. LMF transmits or provides, to AMF, assistance data (or auxiliary information) required for LMF-based cube-level UE location measurement. The assistance data (or information) described above refers to information required for the UE or RAN to measure the location of the UE, and information on at least one of the following may be included in the assistance data (or information).

[TAI, Cell ID, TA-specific cube map information, cell-specific cube map information, DL-PRS configuration information for transmitter/receiver points(s) of the RAN, SSB for RAN TRPs, spatial direction information of the DL-PRS, and geographical coordinate information for TRPs]

The conditions under which the LMF provides such assistance data (or information) may be as follows. When the LMF receives an assistance data request from the AMF, receives a request from an external application function (via the NEF), or the service area of the LMF overlaps with the cube-level mobility management area, the LMF may provide assistance data to the AMF within the LMF service area.

2. The AMF transmits, to the RAN, assistance data required for LMF-based cube-level UE location measurement received from the LMF. At this time, the AMF may not provide, to the RAN, cube map information (TA-specific cube map information and cell-specific cube map information) among the information received from the LMF. For example, when using LMF-based positioning, the AMF may not provide cube map information to the RAN.

3. The RAN transmits, to the UE, assistance data required for LMF-based cube-level UE location measurement received from the AMF.

The methods by which RAN transmits the aforementioned information to the UE may follow two approaches, as described below. The RAN may include the information in a broadcast message and broadcast and transmit the same periodically. Alternatively, when the UE transmits, to the RAN, an on-demand system information block (SIB) message including a cube-level positioning, cube-level mobility management indicator, or flag, the RAN may include the assistance data in a response message and transmit the same to the UE.

4. The UE generates a measurement value required for calculating the UE location (measurement value required for determining the UE location in the LMF) by utilizing at least one of information received from the RAN, a GPS module installed inside the UE, and a sensor. The UE may perform an operation of transmitting the corresponding measurement value to the LMF via the RAN and AMF.

Specifically, the UE generates concealed UE measurement by performing concealment on the generated measurement value by using the home network public key configured in the UE. For example, when the UE measurement concealing indication is configured in the USIM of the UE, the UE may calculate and generate concealed UE measurement by using the home network public key stored in the USIM. When the concealed UE measurement is not configured in the USIM, the UE may encrypt the measurement value by using another encryption method.

5. The UE transmits the generated concealed cube ID to the AMF. The UE may include the concealed cube ID in the registration request message to transmit the same. When the UE transmits the concealed cube ID to the AMF, the UE may provide at least one of a method by which the UE encrypted the measurement value (UE measurement) or a UE measurement concealment method (e.g., whether to use a home network public key, encryption scheme information, etc.), and a UE identifier along with a fine-grained MM support indication.

6. The AMF may transmit, to the LMF, concealed UE measurement, UE measurement concealment method, UE identifier, and fine-grained MM support indication, received from the UE. In addition, the AMF may identify the subscriber information of the UE before transmitting the information to the LMF to identify whether the UE supports fine grained MM. When the UE does not support the fine-grained MM, based on the confirmation by the AMF, the following operations may not be performed.

7. The LMF receives the concealed UE measurement and, when the UE measurement concealment method uses the home network public key, the LMF may transmit the concealed UE measurement along with the UE identifier to the UDM while performing a de-concealment request.

8, 9. The UDM may identify whether the request from the LMF is allowed, perform de-concealment, and then transmit the UE measurement value (de-concealed UE measurement) to the LMF along with the UE identifier.

Note: The operations 6 to 9 may follow a modified procedure as follows. Instead of the operation in which the AMF transmits the concealed UE measurement to the LMF, the AMF may transmit a de-concealment request to the UDM and obtain the de-concealed UE measurement from the UDM. The AMF may transmit the de-concealed UE measurement value to the LMF.

10. The LMF calculates the location of the UE by using the obtained UE measurement value (de-concealed UE measurement) and cube map information, and determines the cube ID of the cube area where the UE is located.

11. The LMF transmits, to the AMF, the cube ID (cube ID of the cube area where the UE is located) determined in the previous operation.

12. The AMF provides the received cube ID to the RAN and may perform AM policy enforcement for the corresponding UE as in operation 9 of the embodiment described in FIG. 3 above.

13. The AMF transmits, to the UE, the obtained cube ID (de-concealed cube ID), reporting triggering condition (list of neighbor cube ID list), and flag to perform cube-level mobility tracking.

The UE identifies whether the cube ID received from the AMF matches the cube ID determined in operation 4 by the UE. The UE monitors whether the UE exits the cube area identified by the cube ID included in the cube ID list included in the reporting triggering condition provided by the AMF, and when it is detected that the UE exits the area, the UE may transmit the UE measurement value to the LMF via the AMF as in the operations above (after the initial registration, the concealment operation performed in operation 4 may not be performed when transmitting the UE measurement value).

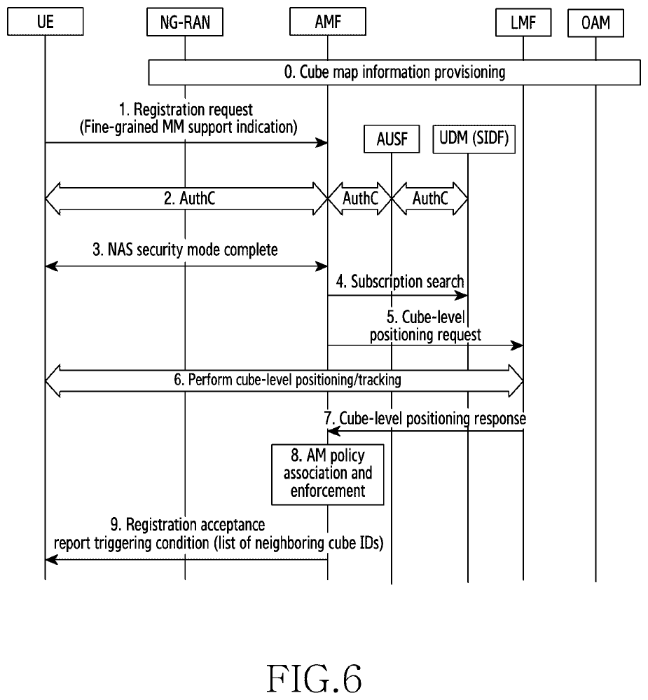

FIG. 6 illustrates a procedure for managing UE mobility, based on a detailed location in relation to an embodiment proposed in the disclosure. FIG. 6 specifically explains the operation after the NAS security mode control procedure is completed, in relation to the mobility management procedure, based on the LMF.

0. As in the embodiment described in FIG. 3 and FIG. 4, the OAM system may configure the cube map information for network entities (or functions) such as the RAN, AMF, and LMF. According to the operator policy or the method for calculating UE location and determining the cube ID of the cube area where the UE is located, the cube map information may not be configured to the RAN. For example, when using a method for finally calculating the UE location in the network (e.g., LMF) and determining the cube ID, the cube map information may be configured only to the AMF and LMF and may not be configured to the RAN.

1. The UE may transmit, to the AMF, a registration request message including the UE identifier and at least one of fine-grained MM support indication, cube-level MM support indication, or UE capability to support cube-level MM.

2. The AMF performs an authentication procedure in conjunction with the UE, AUSF, and UDM, based on the information received from the UE.

3. After completing the authentication procedure, the AMF performs an NAS security mode configuration procedure with the UE.

4. When the information received from the UE includes a fine-grained MM support indication, a cube-level MM support indication, or a UE capability to support cube-level MM, the AMF may obtain, from the UDM, subscriber information related to whether the fine-grained MM or cube-level MM is allowed for the UE. At this time, the UDM may provide, to the AMF, information on whether the fine-grained MM or cube-level MM is allowed, based on the subscriber information.

5. The AMF identifies whether the fine-grained MM or cube-level MM is allowed, based on the information received from the UDM or the subscriber information, and the AMF transmits, to the LMF, a cube-level positioning request message including at least one of the UE identifier, information indicating that the cube-level MM is allowed, and cell or TA information where the UE is currently located.

6. The LMF performs a cube-level positioning operation to specify (or confirm) the UE location in a cube unit according to the request of the AMF. For example, the LMF may perform the operations described in operations 1, 2, and 3 of the embodiment illustrated in FIG. 3 to transmit, to the RAN and the UE, cube map information and assistance data necessary for measuring the UE location on a cube unit basis.

The UE may measure the UE location as in the operation 4 of the embodiment illustrated in FIG. 3, determine a cube ID corresponding to the location, and provide the same to the LMF (alternatively, unlike the operation of the embodiment illustrated in FIG. 3, the UE may not perform a separate concealment for the cube ID, but may include the cube ID in an NAS container and transmit the same to the LMF via the AMF). As another example, the LMF may perform the operations 1, 2, and 3 described in the embodiment illustrated in FIG. 5, and the UE may generate a measurement value required for location calculation (measurement value required for the LMF to determine the UE location) and transmit the generated measurement value to the LMF (via the AMF).

7. The LMF determines the cube ID corresponding to the UE location via the cube ID obtained from the UE in the previous operation or the measurement value required for location calculation, and transmits the cube ID to the AMF.

8. The AMF may perform the AM policy by using the cube ID received from the LMF. For example, the AMF may provide, to the PCF, the cube ID of the cube where the UE is located, and receive, from the PCF, policy information that should be applied in the corresponding cube area. The policy information that the AMF may receive from the PCF may include the following.

Cube-level mobility restriction or service area restriction (allowed cube ID list, non-allowed cube ID list)

Cube-level RFSP (RAT Frequency Selection Priority) Index value: RAT Frequency Selection Priority value configured for the cube area, which may correspond to the subscriber profile ID for RAT/Frequency Priority

Cube-level UE-AMBR (aggregate maximum bitrate) or UE Slice-maximum bitrate (MBR)

When AMF receives AM policy including cube-level RFSP Index from PCF, the AMF may deliver RFSP Index value to RAN and perform RAT/Frequency selection, based on RAT Frequency selection priority in the RAN. In addition, the AMF may provide, to the RAN, cube ID matching location of the UE.

9. The AMF transmits, to the UE, the cube ID (de-concealed cube ID) obtained from the LMF, reporting triggering condition (list of neighbor cube ID list), and flag to perform cube-level mobility tracking. The AMF may also perform subscription request to cube-level UE mobility tracking notification service that receives notification when the UE location measurement value performed by the LMF matches reporting triggering condition, while transmitting reporting triggering condition to the LMF.

After operation 9, the UE identifies whether the cube ID received from the AMF matches the cube ID determined in operation 6 by the UE, and monitors whether the UE exits the cube area identified by the cube ID included in the cube ID list included in the reporting triggering condition provided by the AMF. The UE may perform monitoring via the cube-level positioning of the UE and LMF as in operation 6. When the UE or the LMF exits the cube area included in the cube ID list included in the reporting triggering condition and enters a new cube area, the AMF transmits a new cube ID. For example, the UE may transmit, to the AMF, a registration request message including a new cube ID, and the LMF may transmit, to the AMF, a cube-level UE mobility tracking notification message including a new cube ID.

The combination and modification of the specific operations of the various embodiments described above may occur in each device. In the method of determining a cube ID corresponding to UE location, the UE may directly calculate the UE location by using the cube map information provided by the RAN or the AMF or the LMF and the auxiliary information required for measuring the UE location in a cube unit, and determine the cube ID corresponding to the UE location.

Alternatively, the UE may provide, to the RAN or the LMF, the measurement value required for calculating the location, and the determination of the UE location and the cube ID may be performed in the RAN or the LMF.

In the method of transmitting a cube ID corresponding to the UE location or a measurement value required for calculating the UE location, the UE may include, after performing concealment on the corresponding information, the information in the initial registration request message and transmit the same to the AMF, or may include the same in the NAS container after completing the NAS security mode configuration procedure and transmit the same, without further performing a separate concealment operation. In this regard, the AMF may directly use the cube ID received from the UE or the measurement value required for calculating the UE location (utilize the cube ID for AM policy enforcement or obtain the cube ID by transmitting the measurement value to LMF), or obtain and use the de-concealed cube ID or measurement value by using the de-concealment service provided by UDM.

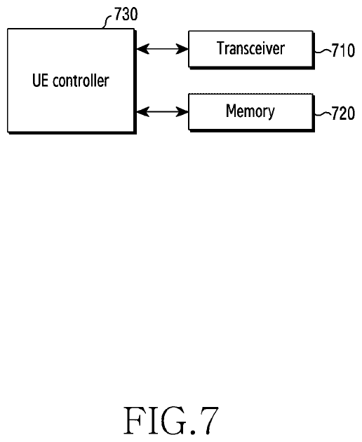

FIG. 7 illustrates a structure of a UE according to embodiments of the disclosure.

As illustrated in FIG. 7, the UE according to the disclosure may include a transceiver 710, a memory 720, and a controller (or a processor 730). The controller 730, the transceiver 710, and the memory 720, included in the UE, may operate according to the communication method of the UE described above. However, the components of the UE are not limited to the examples described above. For example, the UE may include more or fewer components than the components described above. In addition, the controller 730, the transceiver 710, and the memory 720 may be implemented as a single chip.

The transceiver 710 collectively refers to the receiver and transmitter of a UE, enabling signal transmission and reception with a base station or network entity. The signals transmitted and received to and from the base station may include control information and data. To this end, the transceiver 710 may include a radio frequency (RF) transmitter configured to up-convert and amplify the frequency of a transmitted signal, and an RF receiver configured to low-noise amplify a received signal and down-convert the frequency thereof. However, this is only one example of the transceiver 710, and the components of the transceiver 710 are not limited to the RF transmitter and RF receiver.

In addition, the transceiver 710 may include a wired or wireless transceiver and may include various configurations for transmitting and receiving signals. In addition, the transceiver 710 may receive a signal via a wireless channel, output the signal to the controller 730, and transmit the signal output from the controller 730 via the wireless channel. In addition, the transceiver 710 may receive a communication signal and output the signal to the controller 730, and may transmit the signal output from the controller 730 to a base station or network entity via a wired or wireless network.

The memory 720 may store programs and data required for the operation of the UE. In addition, the memory 720 may store control information or data included in a signal acquired from the UE. The memory 720 may be configured by a storage medium including ROM, RAM, hard disks, CD-ROMs, DVDs, and the like or a combination of the storage media.

The controller 730 may control a series of processes to enable the UE to operate according to the embodiment of the disclosure described above. The controller 730 may include at least one processor. For example, the controller 730 may include a communication processor (CP) that performs control for communication and an application processor (AP) that controls upper layers such as application programs.

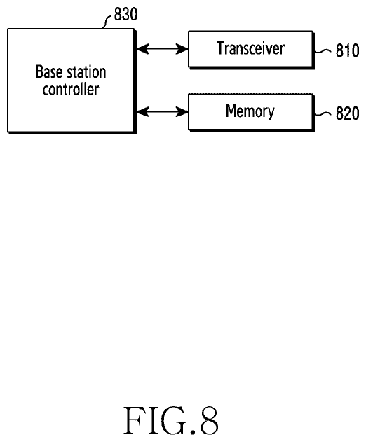

FIG. 8 illustrates a structure of a base station according to embodiments of the disclosure. The base station illustrated in FIG. 8 may correspond to the RAN node described above in FIG. 1.

As illustrated in FIG. 8, the base station according to the disclosure may include a transceiver 810, a memory 820, and a controller (or, processor, 830). The controller 830, the transceiver 810, and the memory 820, included in the base station, may operate according to the communication method of the base station described above. However, the components of the base station are not limited to the examples described above. For example, the base station may include more or fewer components than the components described above. According to one embodiment, the base station in FIG. 8 may be implemented with the entire function split into a CU and a DU. In such case, the CU and the DU may each perform some of the functions performed by the base station in FIG. 8. In addition, the controller 830, the transceiver unit 810, and the memory 820 in FIG. 8 may be implemented as a single chip.

The transceiver 810 collectively refers to the receiver and transmitter of the base station, enabling signal transmission and reception with a UE or network entity. The transmitted and received signals may include control information and data. To this end, the transceiver 810 may include a radio frequency (RF) transmitter configured to up-convert and amplify the frequency of a transmitted signal, and an RF receiver configured to low-noise amplify a received signal and down-convert the frequency thereof. However, this is only one example of the transceiver 810, and the components of the transceiver 810 are not limited to the RF transmitter and RF receiver. The transceiver 810 may include a wired or wireless transceiver and may include various configurations for transmitting and receiving signals.

In addition, the transceiver 810 may receive a signal via a wireless channel (e.g., a wireless channel), output the signal to the controller 830, and transmit the signal output from the controller 830 via the wireless channel. In addition, the transceiver 810 may receive a communication signal, output the same to the processor, and transmit the signal output from the processor to a UE or network entity via a wired or wireless network.

The memory 820 may store programs and data required for the operation of the base station. In addition, the memory 820 may store control information or data included in a signal acquired from the base station. The memory 820 may be configured by a storage medium including ROM, RAM, hard disks, CD-ROMs, DVDs, and the like or a combination of the storage media.

The controller 830 may control a series of processes to enable the base station to operate according to the embodiment of the disclosure described above. The controller 830 may include at least one processor. The methods according to the embodiments described in the claims or specification of the disclosure may be implemented in the form of hardware, software, or a combination of hardware and software.

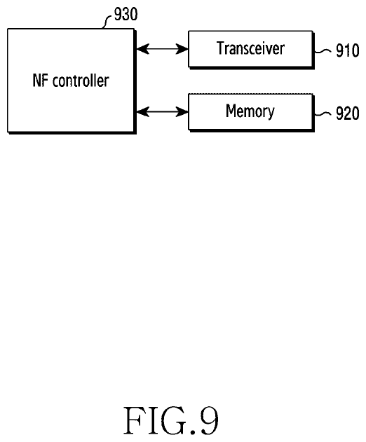

FIG. 9 illustrates a structure of a network function (or network entity) according to embodiments of the disclosure. The network function (or network entity) illustrated in FIG. 9 may correspond to various nodes of the core network described in FIG. 1 above.

As illustrated in FIG. 9, the network function (or network entity) of the disclosure may include a transceiver 910, a memory 920, and a controller (or processor, 930). The controller 930, the transceiver 910, and the memory 920, included in the network function (or network entity), may operate according to the communication method of the network function (or network entity) described above. However, the components of the network function (or network entity) are not limited to the examples described above. For example, the network function (or network entity) may include more or fewer components than the components described above.

The transceiver 910 collectively refers to the receiver of the network function (or network entity) and transmitter of the base station, enabling signal transmission and reception with a UE, a base station, and/or other network functions (or network entities). At this time, the transmitted and received signals may include control information and data. To this end, the transceiver 910 may communicate with nodes of the core network via a wired or wireless transceiver. However, this is only one embodiment of the transceiver 910, and the components of the transceiver 910 may include an RF transmitter configured to up-convert and amplify the frequency of a transmitted signal, and an RF receiver configured to low-noise amplify a received signal and down-convert the frequency thereof and may include various configurations for transmitting and receiving signals.

In addition, the transceiver 910 may receive a signal through a communication channel (e.g., a wireless channel or a channel of a core network) and output the same to the controller 930, and transmit the signal output from the controller 930 via the communication channel. In addition, the transceiver 910 may receive a communication signal and output the same to the controller 930, and transmit the signal output from the controller 930 to a UE, a base station, or a network entity via a wired or wireless network.

The memory 920 may store programs and data necessary for the operation of the network function (or network entity). In addition, the memory 920 may store control information or data included in a signal acquired from the network function (or network entity). The memory 920 may be configured by a storage medium including ROM, RAM, hard disks, CD-ROMs, DVDs, and the like or a combination of storage media.

The controller 930 may control a series of processes to enable the network function (or network entity) to operate according to the embodiment of the disclosure described above. The controller 930 may include at least one processor. The methods according to the embodiments described in the claims or specification of the disclosure may be implemented in the form of hardware, software, or a combination of hardware and software.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. For example, a part or all of an embodiment may be combined with a part or all of one or more other embodiments, and it is natural that an implementation of such combination also corresponds to an embodiment proposed by the disclosure. Therefore, the scope of the disclosure should not be defined as being limited to the embodiments set forth herein, but should be defined by the appended claims and equivalents thereof.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. An access mobility and management function (AMF) node in a wireless communication system, the AMF node comprising:
a transceiver; and
a controller coupled with the transceiver,
wherein the controller is configured to:
receive configuration information configuring at least one cube associated with a three-dimensional space within a cell;
receive, from a location management function (LMF) node, auxiliary information for location measurement;
transmit, to a terminal, the auxiliary information for location measurement;
receive, from the terminal, concealed information associated with location measurement of the terminal;
identify a cube identifier (ID) associated with the terminal, based on the concealed information associated with location measurement of the terminal;
determine whether a mobility management policy based on the cube ID is allowed to be applied to the terminal; and
transmit, to the terminal, information on the mobility management policy.

2. The AMF node of claim 1,
wherein the concealed information associated with location measurement of the terminal includes a registration request message including a cube ID concealed by the terminal and an indicator requesting mobility management based on the at least one cube, and
wherein the cube ID concealed by the terminal is de-concealed by a unified data management (UDM) node.

3. The AMF node of claim 1, wherein the controller is further configured to:
receive, from the terminal, a registration request message including an indicator requesting mobility management based on at least one cube,
perform an authentication procedure of the terminal, based on the registration request message, and
transmit, to the terminal, a non-access stratum (NAS) command message based on a result of the authentication procedure,
wherein the concealed information associated with location measurement of the terminal includes an NAS container including a cube ID associated with the terminal, the cube ID being determined by the terminal.

4. The AMF node of claim 1,
wherein the concealed information associated with location measurement of the terminal includes a registration request message including a result of location measurement concealed by the terminal and an indicator requesting mobility management based on the at least one cube, and
wherein the controller is further configured to:
transmit, to the LMF node, the result of the location measurement concealed by the terminal; and
receive, from the LMF node, a cube ID associated with the terminal and determined based on the result of the location measurement.

5. The AMF node of claim 1, wherein the controller is further configured to:
receive, from the terminal, a registration request message including an indicator requesting mobility management based on the at least one cube;
perform an authentication procedure of the terminal, based on the registration request message; and
transmit, to the terminal, a non-access stratum (NAS) command message, based on the result of the authentication procedure, and
wherein the cube ID associated with the terminal is determined by the LMF note, based on the result of the location measurement of the terminal.

6. The AMF node of claim 1, wherein the concealed information associated with location measurement of the terminal is generated based on a cube ID associated with the terminal or a result of location measurement of the terminal and a home network public key.

7. A terminal (user equipment (UE)) in a wireless communication system, the terminal comprising:
a transceiver; and
a controller coupled with the transceiver,
wherein the controller is configured to:
receive, from an access mobility and management function (AMF) node, configuration information configuring at least one cube associated with a three-dimensional space within a cell;
receive, from the AMF node, auxiliary information for location measurement;
generate concealed information associated with location measurement of the terminal, based on the configuration information and the auxiliary information;
transmit, to the AMF node, the concealed information associated with location measurement of the terminal; and
receive, from the AMF node, information on a mobility management policy generated based on the concealed information associated with location measurement of the terminal.

8. The terminal of claim 7, wherein the concealed information associated with location measurement of the terminal includes a cube ID concealed by the terminal and an indicator requesting mobility management based on the at least one cube.

9. The terminal of claim 7, wherein the concealed information associated with location measurement of the terminal includes a result of location measurement concealed by the terminal and an indicator requesting mobility management based on the at least one cube.

10. A method performed by an access mobility and management function (AMF) node in a wireless communication system, the method comprising:
receiving configuration information configuring at least one cube associated with a three-dimensional space within a cell;
receiving, from a location management function (LMF) node, auxiliary information for location measurement;
transmitting, to a terminal, the auxiliary information for location measurement;
receiving, from the terminal, concealed information associated with location measurement of the terminal;
identifying a cube identifier (ID) associated with the terminal, based on the concealed information associated with location measurement of the terminal;
determining whether a mobility management policy based on the cube ID is allowed to be applied to the terminal; and
transmitting, to the terminal, information on the mobility management policy.

11. The method of claim 10,
wherein the concealed information associated with location measurement of the terminal includes a registration request message including a cube ID concealed by the terminal and an indicator requesting mobility management based on the at least one cube, and
wherein the cube ID concealed by the terminal is de-concealed by a unified data management (UDM) node.

12. The method of claim 10, further comprising:
receiving, from the terminal, a registration request message including an indicator requesting mobility management based on the at least one cube;
performing an authentication procedure of the terminal, based on the registration request message; and
transmitting, to the terminal, a non-access stratum (NAS) command message based on a result of the authentication procedure,
wherein the concealed information associated with location measurement of the terminal includes an NAS container including a cube ID associated with the terminal, the cube ID being determined by the terminal.

13. The method of claim 10,
wherein the concealed information associated with location measurement of the terminal includes a registration request message including a result of location measurement concealed by the terminal and an indicator requesting mobility management based on the at least one cube, and
wherein the method further comprises:
transmitting, to the LMF node, the result of the location measurement concealed by the terminal; and
receiving, from the LMF node, a cube ID associated with the terminal and determined based on the result of the location measurement.

14. The method of claim 10, further comprising:
receiving, from the terminal, a registration request message including an indicator requesting mobility management based on the at least one cube;
performing an authentication procedure of the terminal, based on the registration request message; and
transmitting, to the terminal, a non-access stratum (NAS) command message based on a result of the authentication procedure, and
wherein the cube ID associated with the terminal is determined by the LMF node, based on the result of the location measurement of the terminal.

15. The method of claim 10, wherein concealed information associated with location measurement of the terminal is generated based on a cube ID associated with the terminal or a result of location measurement of the terminal and a home network public key.
